(19) United States
(12) Patent Application Publication
(10) Pub. No.: US 2010/0251813 A1
(43) Pub. Date: Oct. 7, 2010

(54) DEVICE FOR MONITORING THE CIRCULATION OF A FLUID AT AN OPENING AND CIRCUIT THAT COMPRISES SUCH A DEVICE

(75) Inventors: Nicolas BECKER, Colmar (FR); Alexandre FLORANC, Sainte Croix en Plaine (FR); Francois COTTET, Freland (FR); David GUYON, Ingersheim (FR)

Correspondence Address: YOUNG & THOMPSON, 209 Madison Street, Suite 500, Alexandria, VA, 22314, US

(73) Assignee: MARK IV SYSTEMES MOTEURS, Levallois Perret (FR)

(21) Appl. No.: 12/753,213

(22) Filed: Apr. 2, 2010

(30) Foreign Application Priority Data
Apr. 3, 2009 (FR) 09 52217

(51) Int. Cl. G01F 15/00

(52) U.S. Cl. 73/198

(57) ABSTRACT

A device for monitoring circulation of a fluid at a first opening includes a housing through which fluid passes, the first opening to be monitored, at least a second opening that empties into a chamber of the housing, and a sealing element that can shift or be moved, in a reversible manner, from one closed position in which it seals the first opening to at least one open position in which it releases the opening and allows fluid circulation. The sealing element is capable of being deployed in the chamber, and its movement is controlled by at least one activating element. The sealing element includes a moving body that forms a piston whose one end part is configured to seal the first opening and a portion of membrane is sandwiched between the end part of the moving body and at least the edge that forms a seat of the first opening.

### FIELD OF THE INVENTION

This invention relates to the field of fluid regulation and has as its object a device for monitoring the circulation of a fluid, in particular a liquid, at an opening or an entrance of a passage, or else an entrance or exit opening, for example a pipe segment.

In particular, the applications linked to the circulation of liquid in the circuits for cooling internal combustion engines or the like are the object of the invention.

### BACKGROUND OF THE INVENTION

Numerous embodiments are already known of devices for regulating or monitoring the circulation of a fluid, in particular a liquid, in which a moving element can be moved between an open and a closed position of a passage orifice that is to be monitored.

In particular, devices have been proposed that essentially comprise, on the one hand, a hollow body that has the passage opening that is to be monitored, as well as at least a second entrance or exit passage opening for the fluid, and, on the other hand, a sealing element that can shift or be moved, in a reversible manner, from one state or one closed position in which it seals the opening that is to be monitored to at least one position or one open state in which it releases the opening that is to be monitored and allows a circulation of fluid between the opening that is to be monitored and said at least one second opening through at least one part or region of a chamber that is bound by said hollow body, whereby the sealing element is capable of being deployed, optionally to varying extents, in the chamber, and its movement or change of state is controlled by at least one activating means.

The fluid whose circulation is to be regulated may or may not pass through the chamber of the hollow body or at least a determined region of the latter.

Such is in particular the case of flap valves or piston valves, for example two-state (“ON” and “OFF”) valves for a coolant circuit.

However, these known devices use multiple dynamic seals, have a complex structure, and a high cost, and are stable for a limited time.

In addition, for these known devices, the number of constituent pieces is high, the assembly generally tedious because it requires great precision and the production of pieces made of several necessary materials.

In addition, the release in the open position of the closing element allows only a limited flow because of an excessive pressure drop.

### SUMMARY OF THE INVENTION

The object of this invention is to eliminate at least some of the above-mentioned drawbacks.

For this purpose, it has as its object a device for monitoring the circulation of a fluid at an entrance or exit passage opening, for example a pipe segment,

whereby said device essentially comprises, on the one hand, a hollow body that has the opening that is to be monitored, as well as at least a second entrance or exit passage opening for the fluid, and, on the other hand, a sealing element that can shift or be moved in a reversible manner from one state or a closed position in which it seals the opening that is to be monitored to at least one position or one open state in which it releases the opening that is to be monitored and allows a circulation of fluid between the opening that is to be monitored and said at least one second opening through at least one portion or region of a chamber that is bound by said hollow body,

whereby the sealing element is able to be deployed, optionally to varying extents, in the chamber, and its movement or change of state is controlled by at least one activating means,

whereby the sealing element comprises a moving body that forms a piston or valve and whose end portion is configured to be able to seal, in a closed position, the passage opening that is to be monitored and a portion of membrane made of an elastic material being sandwiched between the end part of the moving body and at least the edge that forms the seat of the passage opening that is to be monitored, in an airtight sealing position of said opening by said moving body,

device that is characterized in that the membrane is part of the airtight boundary of the chamber by forming a zone or wall component that is at least partially deformable of the hollow body and in that, in the open position of the composite sealing element, the moving body (8), in particular its end part, and the membrane, in particular its portion, are located essentially outside of the region of the chamber through which passes the majority of the fluid flow that circulates between the opening that is to be monitored and said at least one second opening.

### BRIEF DESCRIPTION OF THE DRAWINGS

The invention will be better understood using the description below, which relates to preferred embodiments, provided by way of nonlimiting examples and explained with reference to the accompanying diagrammatic drawings, in which:

FIG. 1 is a composite of two diagrammatic axial cutaway half-views of a device for monitoring the circulation of a fluid according to a first embodiment of the invention;

FIGS. 2 and 3 are cutaway views of a monitoring device according to a second embodiment of the invention, in the open (or passing) state and in the closed (or sealed) state;

FIG. 4 is an exploded view of the device of FIGS. 2 and 3, and

FIGS. 5 and 6 are partial cutaway views on a different scale of a monitoring device according to a third embodiment of the invention (in open position in FIG. 5 and in closed position in FIG. 6).

### DETAILED DESCRIPTION OF THE INVENTION

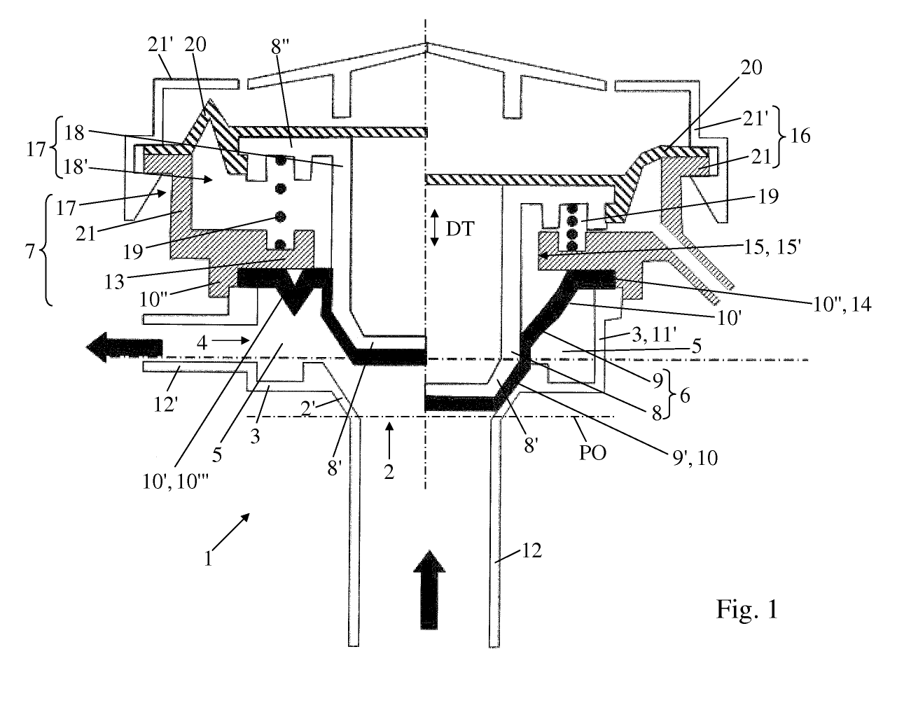

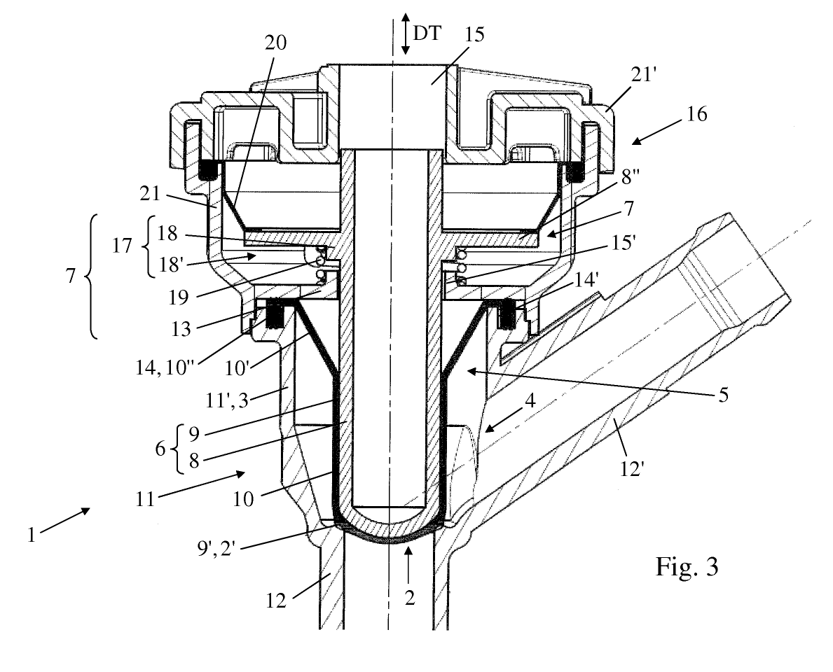

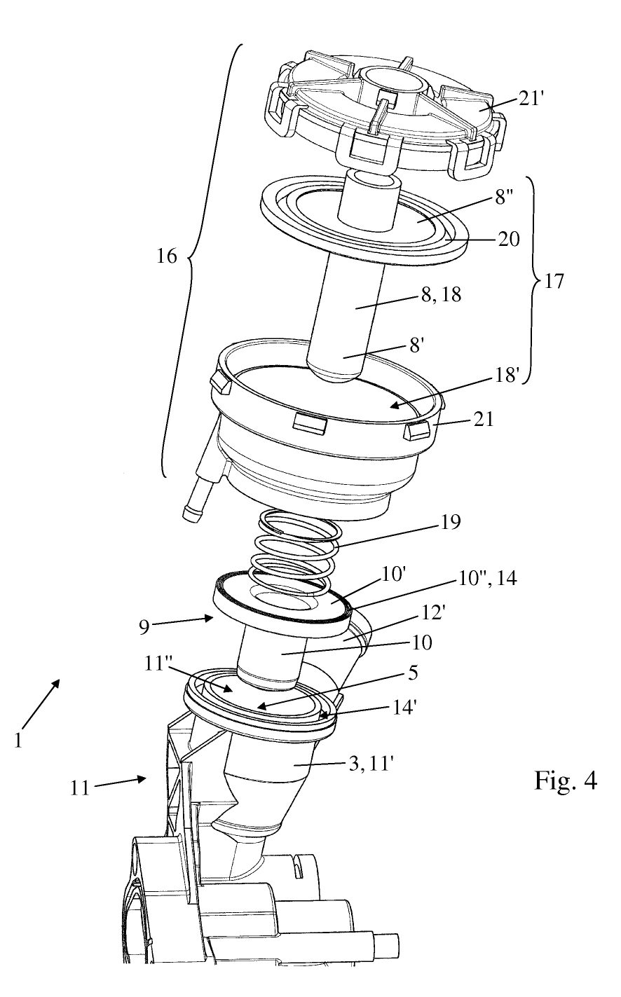

FIGS. 1 to 6 of the accompanying drawings show a device 1 for monitoring the circulation of a fluid at an entrance or exit passage opening 2, for example of a pipe segment 12.

This device 1 essentially comprises, on the one hand, a hollow body 3 that has the opening 2 that is to be monitored, as well as at least a second passage opening 4, and, on the other hand, a sealing element 6 that can shift or be moved, in a reversible manner, from one state or one closed position in which it seals the opening 2 that is to be monitored to at least one position or one open state in which it releases the opening 2 that is to be monitored and allows a circulation of fluid between the opening that is to be monitored and said at least one second opening through at least a part or region of a chamber that is bound by said hollow body, whereby the sealing element 6 is capable of being deployed, optionally to varying extents, in the chamber 5 and its movement or change of state is controlled by at least one activating means 7.

The sealing element 6 comprises a moving body 8 that forms a piston or valve and whose end part 8′ is configured to be able to seal, in closed position, the passage opening 2 that is to be monitored, and a portion 9′ of membrane 9 that is made of an elastic material that is part of the airtight boundary of the chamber 5 is sandwiched between the end part 8′ of the moving body 8 and at least the edge 2′ that forms a seat of the passage opening 2 that is to be monitored in an airtight sealing position of said opening 2 by said moving body 8.

According to the invention, it is provided that the membrane 9 is part of the airtight boundary of the chamber 5 by forming a zone or wall component that is at least partially deformable of the hollow body 3 and that in open position of the composite sealing element 6, the moving body 8, in particular its end part 8′, and the membrane 9, in particular its portion 9′, are located essentially outside of the region 5′ of the chamber 5 through which passes the majority of the fluid flow circulating between the opening 2 that is to be monitored and said at least one second opening 4.

Thus, the moving body 8 of the sealing element 6 is not in contact with the fluid to be regulated and produces the airtight sealing of the passage opening 2 by flattening a portion of a deformable member 9 onto said opening 2. No particular seal, in particular by sliding contact, is therefore necessary between the chamber 5 and the moving element 8, whereby the seal results from the gripping of the membrane between the moving body 8 and the seat 2′ of the opening 2.

In addition, using the above-mentioned arrangements of the invention, it is possible to separate in a simple manner the activating mechanism and the fluid passage chamber since the elastic membrane 9 at the same time forms a part of the wall of the chamber and implements the sealing between the latter and the chamber that contains the activating mechanism of the piston 8, as well as between the latter and the edge of the opening of the passage 2 that is to be monitored.

In addition, in the open position, the pressure drop for the flow that passes through the chamber 5 is limited since the piston 8 and the portion 9′ of the membrane 9 essentially travel outside of the region of the chamber through which the flow passes toward the opening of passage 2.

According to a first constructive characteristic, and as shown in FIGS. 1 to 6, the moving body 8 is a sliding rigid body of which at least the end part 8′ is aligned with the opening 2 that is to be monitored and whose translational direction DT is secant, in an essentially perpendicular manner, with the plane PO of the opening 2 that is to be monitored or the seat 2′ of the latter.

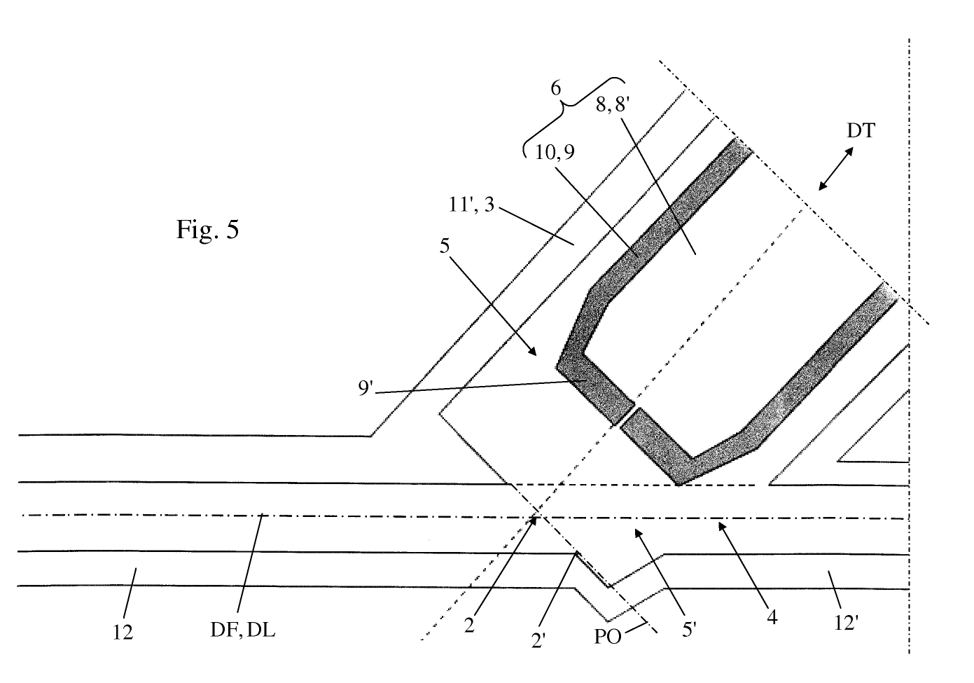

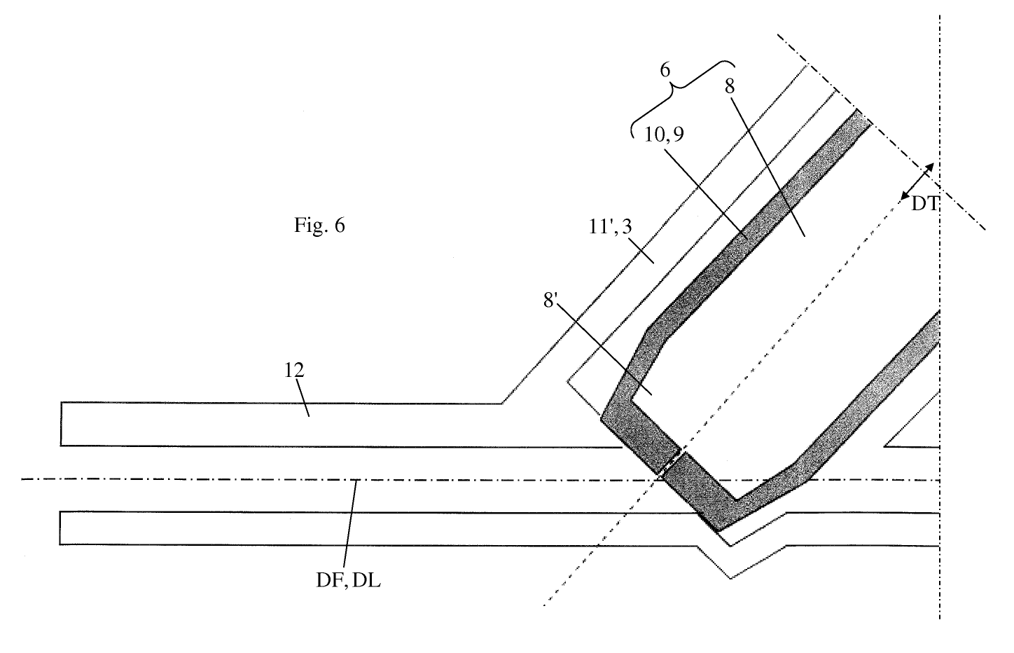

According to a second constructive characteristic—an additional or alternative characteristic relative to the above-mentioned characteristic—evident from FIGS. 5 and 6, the moving body 8 may be a moving body 8 and a sliding rigid body whose translational direction DT is secant, oblique or inclined with the direction DF of the flow through the opening 2 that is to be monitored, if necessary merged with the longitudinal direction DL of the pipe portion 12 that bounds the circulation passage after said opening 2.

Thus, in the two variants, the seal is obtained by a simple translation with abutment.

As the figures also show, the monitoring device 1 can comprise a hollow body 3 that forms a housing that bounds a chamber 5 for effective circulation and distribution of fluid (FIGS. 1 to 4), or a hollow body 3 that is connected as a regulatory accessory between two pipe segments 12 and 12′ by then being very partially passed through by the fluid (FIGS. 5 and 6).

So as to obtain a precise wedging of the membrane 9 relative to the moving body 8, as well as the gripping of a predetermined zone of the membrane 9 for forming the sealing joint by compression between the body 8 and the seat 2′, the membrane 9 has a part 10 that projects toward the interior of the chamber 5 of the housing 3 in the form of an image that essentially corresponds, in reverse, to at least the end part 8′ of the moving body 8.

In addition, by providing an open position with the moving body 8 in a position that is already deployed in the chamber 5, the movement of said body 8 is limited between the two open and closed positions.

Consistent with an advantageous variant embodiment of the invention, making it possible to bound zones of the membrane 9 integral with separate specific functionalities, the latter can form a zone or a wall component that is at least partially deformable from the hollow body 3 and can consist of a central projecting part 10 that accommodates at least the end part 8′ of the moving body 8 by covering it closely by an elastically deformable intermediate part 10′ during the sliding of the moving body 8 toward the interior of the chamber 5 and with radial extension, for example essentially annular extension, around the projecting part 10 and by an external circumferential part 10″, peripherally extending the intermediate part 10′ and made integral by an airtight assembly with the primary part 11 of the hollow body or housing 3.

By these arrangements, each of the parts 10, 10′, 10″ can be designed to best respond to its function. In particular, the intermediate part 10′ can have a construct that is particularly conducive to deformation by stretching.

It optionally will comprise a reserve of material for this purpose, for example in the form of a fold 10′″ of material of the part 10′ of the membrane 9 (FIG. 1).

So as to prevent a permanent and uncontrolled (if necessary, excessive) deformation of the membrane 9 subjected to the pressure of the fluid in the open position of device 1, the hollow body 3 advantageously comprises a portion of rigid wall 13 that is connected or integral, providing a support surface for the membrane 9, in particular for the part 10′ of this membrane 9 that is subject to a significant deformation during the activation of the sealing element 6 and in addition at least to the end part 8′of the moving body 8 that is covered by said membrane 9.

The result is that all of the parts 10 and 10′ of the membrane 9 that are exposed to the pressure of the fluid are supported by rigid surfaces (moving body 8 and wall portion 13), against which said membrane parts are flattened under the action of the pressure of the fluid in circulation.

One skilled in the art understands, of course, that the activating means 7 of the moving body 8 of the sealing element 6 can have different natures, namely electric, hydraulic or pneumatic, for example, or can be mounted close to or in the housing 3, or installed remotely, by then implementing the control of the sealing element 6 by means of a piece, an element or a mechanism of transmission.

According to a preferred variant embodiment, however, shown in FIGS. 1 to 4 of the accompanying drawings, the activating means 7 of the moving body 8 are mounted in a structure 16 that is connected to the hollow body 5, at the membrane 9 that forms a deformable wall component of said hollow body 3 that bounds the chamber 5, said structure 16, for example, in the form of a second hollow body, comprising a rigid wall portion 13 that provides a support surface for at least a part 10′ of the membrane 9 and that optionally also integrates at least one means 15, 15′ for translational guiding of the moving body 8, preferably at least two aligned bearings 15 and 15′.

According to an advantageous embodiment of the invention, the moving body 8 constitutes the piston of a pneumatic cylinder 17 that is part of the activating means 7 and whose body 18 that contains the control chamber 18′ is connected by, for example, welding, clipping or gluing, to the housing or hollow body 3, with gripping of an outside circumferential part 10″ or at least the peripheral edge of the membrane 9 that forms a deformable wall, whereby the latter thus ensures the seal of the control chamber 18′ relative to the circulation chamber 5 and relative to the outside environment.

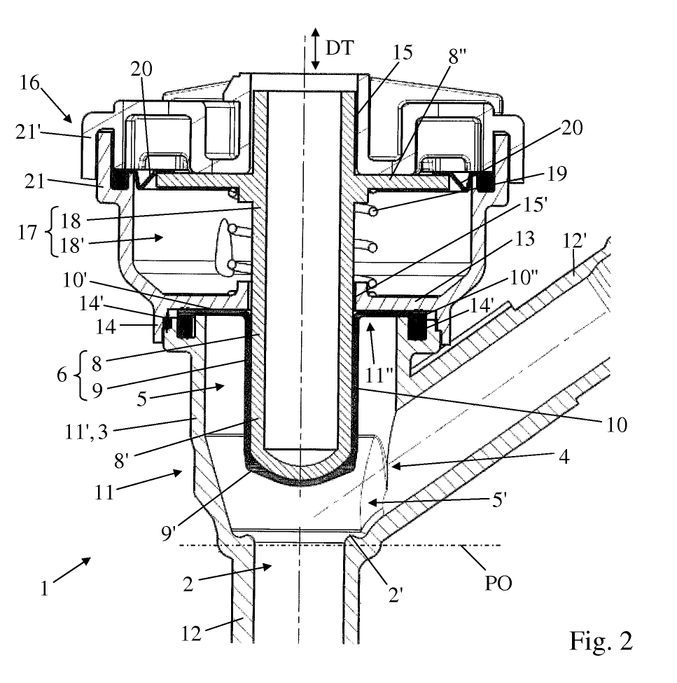

Relative to a nonlimiting, practical embodiment of the device 1 of the invention, for example in the form of a water discharge housing, the housing 3 that bounds the chamber 5 for circulation or distribution of the fluid to be regulated is a hollow composite body that is formed, on the one hand, by a primary part 11 that comprises a rigid envelope 11′ that essentially bounds the circulation chamber 5 and integrates the opening 2 that is to be monitored and at least one other opening 4 that extends into the chamber 5, as well as portions of pipes or end fittings 12, 12′ that extend said openings 2, 4 toward the outside, and optionally formations 13 that provide connecting and/or assembly sites, whereby said rigid envelope 11′ is perforated at its side opposite to the opening 2 that is to be monitored, and, on the other hand, a secondary part 9 that consists of the deformable membrane and that is connected in an airtight manner to the rigid envelope 11′ with sealing of the gap 11″ of said envelope 11′, for example by gripping a peripheral bead 14 of said membrane 9 in a groove 14′ that extends along the edge of the gap 11″ of the envelope 11′ that is sealed by said membrane 9 (FIGS. 2 to 4).

When the moving body 8 is a sliding body, it can advantageously be provided that the device 1 comprises at least one means 15, 15′ for translational guiding of the moving body 8, integrated in a structure 16 that is connected to the housing 3 and that preferably comprises at least two aligned bearings 15 and 15′.

As FIGS. 1 to 4 also show, the moving body 8 is integral with a second membrane 20 that forms an engine element and that separates the control chamber 18′ into two airtight compartments that can be pressurized, depressurized or exposed to the atmosphere, based on the desired movement. This membrane 20 can consist of, for example, a membrane of annular shape that connects a disk-shaped extension 8″ of the moving body 8 at the peripheral wall of the body 18 of the pneumatic cylinder or lung 17.

The structure 16 (integrating in particular the translational guide means 15, 15′) and the pneumatic cylinder 17 can optionally be merged and come in the form of a unique structural unit that is connected to the housing 3.

This structural unit can consist of, for example, two complementary parts, namely a lower tank 21, attached to the housing 3 and integrating the wall portion 13 and a first guide bearing 15′, and an upper cover 21′ that closes the tank 21 in an airtight manner, integrating a second guide bearing 15 and gripping the peripheral edge of the second membrane 20 in an airtight manner against the edge of the tank 21. Each of the two parts is, of course, provided with openings for supply and evacuation of air that empty into the compartments of the control chamber 18′.

For the purpose of integrating a safety function in the opening or in the closing, the activating means can comprise an elastic stress means 19 of the moving body 8 in a position of sealing or release of the opening 2 that is to be monitored (safety in the opening in the accompanying figures—compression spring 19).

This invention also relates to a coolant circulation circuit for an internal combustion engine, characterized in that it comprises a water discharge housing that corresponds to the device 1 as described above.

Of course, the invention is not limited to the embodiments that are described and shown in the accompanying drawings. Modifications are possible, in particular from the standpoint of the composition of the various elements or by substitution of equivalent techniques, without thereby exceeding the scope of protection of the invention.

1. Device for monitoring the circulation of a fluid at an entrance or exit passage opening, for example a pipe segment,
whereby said device (1) essentially comprises, on the one hand, a hollow body (3) that has the opening (2) that is to be monitored, as well as at least a second entrance or exit passage opening (4) for the fluid, and, on the other hand, a sealing element (6) that can shift or be moved in a reversible manner from one state or a closed position in which it seals the opening (2) that is to be monitored to at least one position or one open state in which it releases the opening (2) that is to be monitored and allows a circulation of fluid between the opening (2) that is to be monitored and said at least one second opening (4) through at least one part or region (5′) of a chamber (5) that is bound by said hollow body (3),
whereby the sealing element (6) is capable of being deployed, optionally to varying extents, in the chamber (5), and its movement or change of state is controlled by at least one activating means (7),
whereby the sealing element (6) comprises a moving body (8) that forms a piston or valve and whose end part (8′) is configured to be able to seal, in a closed position, the opening of passage (2) that is to be monitored and a portion (9′) of membrane (9) that is made of an elastic material being sandwiched between the end part (8′) of the moving body (8) and at least the edge (2′) that forms the seat of the opening of passage (2) that is to be monitored, in an airtight sealing position of said opening (2) by said moving body (8),
device (1) that is characterized in that the membrane (9) is part of the airtight boundary of the chamber (5) by forming a zone or wall component that is at least partially deformable of the hollow body (3), and in that, in the open position of the composite sealing element (6), the moving body (8), in particular its end part (8′), and the membrane (9), in particular its portion (9′), are located essentially outside of the region (5′) of the chamber (5) through which passes the majority of the fluid flow that circulates between the opening (2) that is to be monitored and said at least one second opening (4).

2. Device according to claim 1, wherein the moving body (8) is a sliding rigid body of which at least the end part (8′) is aligned with the opening (2) that is to be monitored and whose translational direction (DT) is secant, in an essentially perpendicular manner, with the plane (PO) of the opening (2) that is to be monitored or the seat (2′) of the latter.

3. Device according to claim 1, wherein the moving body (8) is a sliding rigid body whose translational direction (DT) is secant, in an oblique or inclined manner, with the direction (DF) of the flow through the opening (2) that is to be monitored, if necessary merged with the longitudinal direction (DL) of the pipe portion (12) that bounds the circulation passage after said opening (2).

4. Device according to claim 1, wherein the membrane (9) is integral and consists of a central projecting part (10) that accommodates at least the end part (8′) of the moving body (8) by covering it closely by an elastically deformable intermediate part (10′) during the sliding of the moving body (8) toward the interior of the chamber (5) and with a radial extension, for example essentially annular, around the projecting part (10) and by an external circumferential part (10″), peripherally extending the intermediate part (10′) and made integral by an airtight assembly with the primary part (11) of the hollow body or housing (3).

5. Device according to claim 4, wherein the membrane (9) has a part (10) that projects toward the interior of the chamber (5) of the housing (3) in the form of an image that essentially corresponds, in reverse, to at least the end part (8′) of the moving body (8).

6. Device according to claim 1, wherein the hollow body (3) comprises a portion of rigid wall (13) that is connected or integral, providing a support surface for the membrane (9), in particular for the part (10′) of this membrane (9) that is subject to a significant deformation during the activation of the sealing element (6) and in addition to at least the end part (8′) of the moving body (8) that is covered by said membrane (9).

7. Device according to claim 1, wherein the activating means (7) of the moving body (8) are mounted in a structure (16) that is connected to the hollow body (5) at the membrane (9) that forms a deformable wall component of said hollow body (3) that bounds the chamber (5), whereby said structure (16), for example in the form of a second hollow body, comprises a portion of rigid wall (13) that provides a support surface for at least a part (10′) of the membrane (9) and that optionally also integrates at least one translational guide means (15, 15′) of the moving body (8), preferably at least two aligned bearings (15 and 15′).

8. Device according to claim 7, wherein the moving body (8) constitutes the piston of a pneumatic cylinder (17) that is part of the activating means (7) and of which the body (18) that contains the control chamber (18′) is connected by, for example, welding, clipping or gluing, to the housing or hollow body (3), with gripping of an outside circumferential part (10″) or at least the peripheral edge of the membrane (9) that forms a deformable wall, whereby the latter thus ensures the seal of the control chamber (18′) relative to the circulation chamber (5) and relative to the outside environment.

9. Device according to claim 7, wherein the activating means (7) also comprise an elastic stress means (19) of the moving body (8) in a position of sealing or releasing the opening (2) that is to be monitored.

10. Device according to claim 1, wherein the hollow body or housing (3) that bounds the chamber (5) for circulation or distribution of the fluid to be regulated is a hollow composite body that is formed, on the one hand, by a primary part (11) that comprises a rigid envelope (11′) that essentially bounds the circulation chamber (5) and that integrates the opening (2) that is to be monitored and at least one other opening (4) that extends into the chamber (5), as well as portions of pipes or end fittings (12, 12′) that extend said openings (2, 4) toward the outside, whereby said rigid envelope (11′) is perforated at its side that is opposite to the opening (2) that is to be monitored, and, on the other hand, a secondary part (9) that consists of the deformable membrane and that is connected in an airtight manner to the rigid envelope (11′) with sealing of the gap (11″) of said envelope (11′), for example by gripping a peripheral bead (14) of said membrane (9) in a groove (14′) that extends along the edge of the gap (11″) of the envelope (11′) that is sealed by said membrane (9).

11. Device according to claim 1, wherein it consists of a water discharge housing.

12. Coolant circulation circuit for an internal combustion engine, wherein it comprises a water discharge housing that corresponds to the device (1) according to claim 1.

13. Device according to claim 2, wherein the moving body (8) is a sliding rigid body whose translational direction (DT) is secant, in an oblique or inclined manner, with the direction (DF) of the flow through the opening (2) that is to be monitored, if necessary merged with the longitudinal direction (DL) of the pipe portion (12) that bounds the circulation passage after said opening (2).
